(19) United States
(12) Patent Application Publication
(10) Pub. No.: US 2025/0062444 A1
(43) Pub. Date: Feb. 20, 2025

(54) THERMAL BARRIER ASSEMBLY FOR TRACTION BATTERY PACK

(71) Applicant: Ford Global Technologies, LLC, Dearborn, MI (US)

(72) Inventors: Daniel Paul Roberts, Livonia, MI (US); Francisco Fernandez-Galindo, Canton, MI (US); John Hammack McCormick, Clawson, MI (US); David Doman, Canton, MI (US)

(21) Appl. No.: 18/451,882

(22) Filed: Aug. 18, 2023

(51) Int. Cl. H01M 10/658; H01M 10/647; H01M 50/105; H01M 50/178; H01M 50/211

(52) U.S. Cl. CPC H01M 10/658; H01M 10/647; H01M 50/105; H01M 50/178; H01M 50/211; B60L 50/64; H01M 2220/20

(57) ABSTRACT

A traction battery pack assembly includes an enclosure assembly that provides an interior area. A cell stack is disposed within the interior area The cell stack has a plurality of battery cells disposed along a cell stack axis. Terminal tabs of the battery cells project outward from the cell stack axis. A thermal barrier is within the interior area. The thermal barrier has a fingers spaced from each other to provide at least one slot that receives a portion of at least one of the terminal tabs.

### TECHNICAL FIELD

This disclosure relates generally to a thermal barrier for a traction battery pack and, more particularly, to a thermal barrier having a plurality of fingers.

### BACKGROUND

A traction battery pack of an electrified vehicle can include an enclosure assembly that holds groups of battery cells arranged in one or more cell stacks. Open areas within the enclosure can be filled with various types of thermal barriers to help control thermal propagation.

### SUMMARY

In some aspects, the techniques described herein relate to a traction battery pack assembly, including: an enclosure assembly that provides an interior area; a cell stack within the interior area, the cell stack having a plurality of battery cells disposed along a cell stack axis, and a plurality of terminal tabs that project outward from the cell stack axis; and a thermal barrier within the interior area, the thermal barrier having a plurality of fingers spaced from each other to provide at least one slot that receives a portion of at least one of the plurality of terminal tabs.

In some aspects, the techniques described herein relate to a traction battery pack assembly, wherein the plurality of fingers includes at least one first finger on a first side of the cell stack, and at least one second finger on an opposite, second side of the cell stack.

In some aspects, the techniques described herein relate to a traction battery pack assembly, wherein the at least one first finger and the at least one second finger each extend longitudinally from a thermal barrier base that is disposed alongside a third side of the cell stack.

In some aspects, the techniques described herein relate to a traction battery pack assembly, wherein an section of the thermal barrier taken through the at least one first finger, the thermal barrier base, and the at least one second finger has a “C” shape.

In some aspects, the techniques described herein relate to a traction battery pack assembly, wherein the third side is transverse to both the first side and the second side.

In some aspects, the techniques described herein relate to a traction battery pack assembly, wherein the at least one first finger extends longitudinally from the thermal barrier base to a tapered end portion, wherein the at least one second finger extends longitudinally from the thermal barrier base to a tapered end portion.

In some aspects, the techniques described herein relate to a traction battery pack assembly, wherein the at least one first finger and the at least one second finger are a first material, wherein the thermal barrier base is a second material that is different than the first material.

In some aspects, the techniques described herein relate to a traction battery pack assembly, wherein the first material is a closed cell foam, and the second material is a polymer-based material.

In some aspects, the techniques described herein relate to a traction battery pack assembly, wherein the plurality of fingers are a plurality of first fingers that are part of a first thermal barrier comb disposed along a first side of the cell stack, and further including a second thermal barrier comb disposed along an opposite second side of the cell stack, the second thermal barrier comb having a plurality of second fingers spaced from each other to provide at least one slot that receives a portion of at least one of the plurality of terminal tabs.

In some aspects, the techniques described herein relate to a traction battery pack assembly, wherein the thermal barrier is a closed cell foam.

In some aspects, the techniques described herein relate to a traction battery pack assembly, wherein the cell stack is a first cell stack, and further including at least one second cell stack within the interior area.

In some aspects, the techniques described herein relate to a traction battery pack assembly, wherein the plurality of battery cells are a plurality of pouch-style battery cells, each pouch-style battery cell having a crimped edge that projects outward from the cell stack axis about a circumferential perimeter of the pouch-style battery cell, wherein the at least one slot receives a portion of at least one of the crimped edge.

In some aspects, the techniques described herein relate to a traction battery pack assembly, wherein each of the terminal tabs within the plurality of terminal tabs extends through one of the crimped edges.

In some aspects, the techniques described herein relate to a traction battery pack assembly, including: a thermal barrier having a plurality of fingers spaced from each other to provide a plurality of slots, each of the slots within the plurality of slots configured to receives a portion of at least one terminal tab that extends from a battery cell.

In some aspects, the techniques described herein relate to a traction battery pack assembly, wherein the thermal barrier is a closed-cell foam.

In some aspects, the techniques described herein relate to a method of providing a thermal barrier within a battery pack, including: placing a cell stack within an interior area of an enclosure; inserting a thermal barrier into the interior area; and during the inserting, receiving at least one tab terminal of the cell stack within a slot of the thermal barrier.

In some aspects, the techniques described herein relate to a method, wherein the slot is provided between a first finger and a second finger of the thermal barrier.

In some aspects, the techniques described herein relate to a method, wherein the first finger and the second finger are closed-cell foam.

In some aspects, the techniques described herein relate to a method, wherein the first finger and the second finger each have a tapered end portion.

In some aspects, the techniques described herein relate to a method, wherein the first finger and the second finger each extend longitudinally from a thermal barrier base.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1 according to an exemplary aspect of the present disclosure.

FIG. 3 illustrates a battery cell from the battery pack of FIG. 2.

FIG. 4 illustrates a section view of the battery pack of FIG. 2 as a thermal barrier is installed.

FIG. 5 illustrates a perspective view of a corner portion of the battery pack of FIG. 2 as the thermal barrier is installed.

FIG. 6 illustrates a close-up view of an area of FIG. 4.

FIGS. 7A to 7C illustrate various views of one of the thermal barriers from the battery pack of FIG. 2.

FIGS. 8A and 8B illustrate selected views of a thermal barrier according to another exemplary embodiment of the present disclosure.

### DETAILED DESCRIPTION

This disclosure details exemplary thermal barriers used in a traction battery pack. The thermal barriers can, among other things, help to shield battery cells that are not venting from thermal energy associated with a battery cell that is venting. Shielding the battery cells that are not venting from thermal energy can help to prevent thermal energy levels in these battery cells from increasing and causing these battery cells to vent.

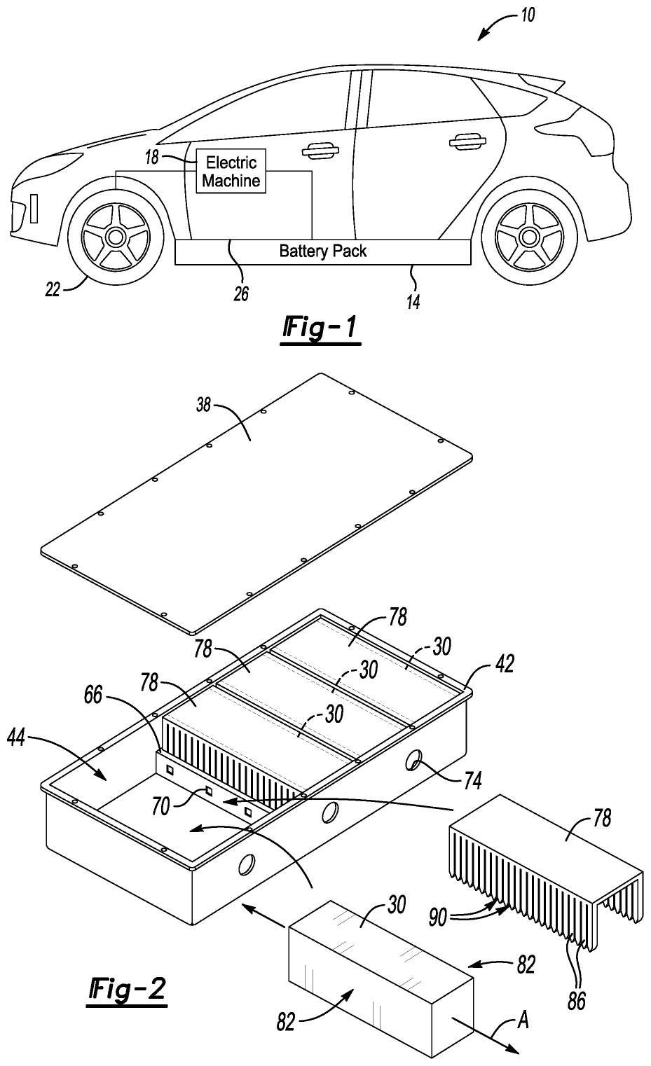

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

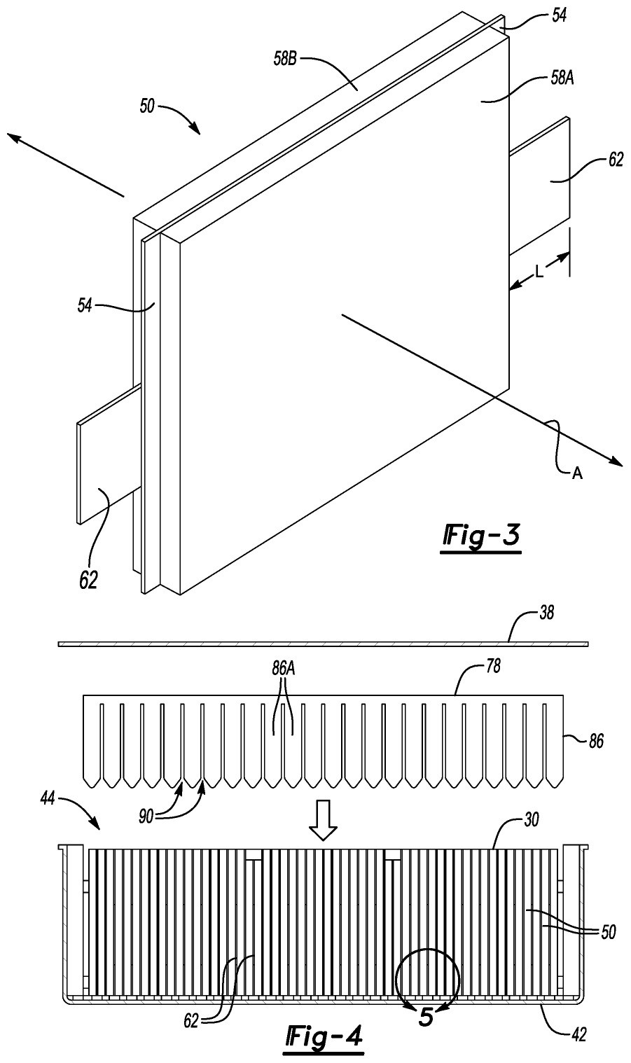

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply, “cells”) disposed along a respective cell stack axis A. Within each cell stack 30, the battery cells 50 are stacked side-by-side relative to each other along the cell stack axis A. The cells 50 are shown in highly schematic form in FIG. 2.

The cells 50 can store and supply electrical power. Although specific numbers of the cell stacks 30 and cells 50 are illustrated in the various figures of this disclosure, the battery pack 14 could include any number of the cell stacks 30 having any number of individual battery cells 50.

In this exemplary embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

The example battery cells 50 include a crimped edge 54 where a first case 58A of the battery cell 50 is joined to a second case 58B of the battery cell 50. The crimped edge 54 can extend partially or completely about a circumferential perimeter of the associated battery cell 50. Terminal tabs 62 of the battery cells 50 project outward away from the cell stack axis A through the crimped edge 54. When the battery cell 50 is within the cell stack 30, the terminal tabs 62 extend outward from the cell stack axis A and can connect to a busbar, for example.

From time to time, pressure and thermal energy within one or more of the battery cells 50 can increase. The pressure and thermal energy increase can be due to an overcharge condition, for example. The pressure and thermal energy increase can cause the associated battery cell 50 to rupture and expel vent byproducts, such as gas and debris, from within the battery cell 50.

The vent byproducts can be released from the associated battery cell 50 through a ruptured area of the associated battery cell 50. The vent byproducts may be releases through a ruptured area of the crimped edge 54. The vent byproducts could also be released through a designated vent within the one or both of the first case 58A and the second case 58B. The designated vent could be a membrane that yields in response to increased pressure.

The battery pack 14, in these examples, includes cross-member assemblies 66 disposed between cell stacks 30. The example cross-member assemblies 66 extend longitudinally in a direction that is parallel to the cell stack axes A. The cross-member assemblies 66 and the cell stack axes A extend in a cross-vehicle direction (i.e., from a driver side to a passenger side). Bus bars that connect to the terminal tabs 62 can be mounted to the cross-member assemblies 66.

In this example, the cross-member assemblies 66 could include venting passageways. Vent byproducts from one or more of the battery cells 50 can move through at least one of the openings 70 into the venting passageway. The vent byproducts are communicated though the venting passageway through an enclosure vent 74 to an area outside the battery pack 14. The openings 70, the enclosure vent 74, or both can be covered by respective membranes, for example, when not venting. During venting, the vent byproducts can rupture the membranes so that the vent byproducts can flow from the battery cells 50, through the openings 70 to the venting passageway and then through the enclosure vent 74.

In another example, vent byproducts from one or more of the battery cells 50 is routed through one or move vents in the enclosure cover 38 of the traction battery pack 14. Other methods of conveying vent byproducts from the traction battery pack 14 are possible and fall within the scope of this disclosure.

The battery pack 14 includes a plurality of thermal barriers 78 within the interior area 44. The thermal barriers 78 include portions disposed along at least outboard sides 82 of the cell stacks 30. When one or more of the cells 50 within a given cell stack 30 is venting through one of the outboard sides 82, the thermal barrier 78 along that outboard side 82 can help to block thermal energy from swirling back against other battery cells 50 that are not venting.

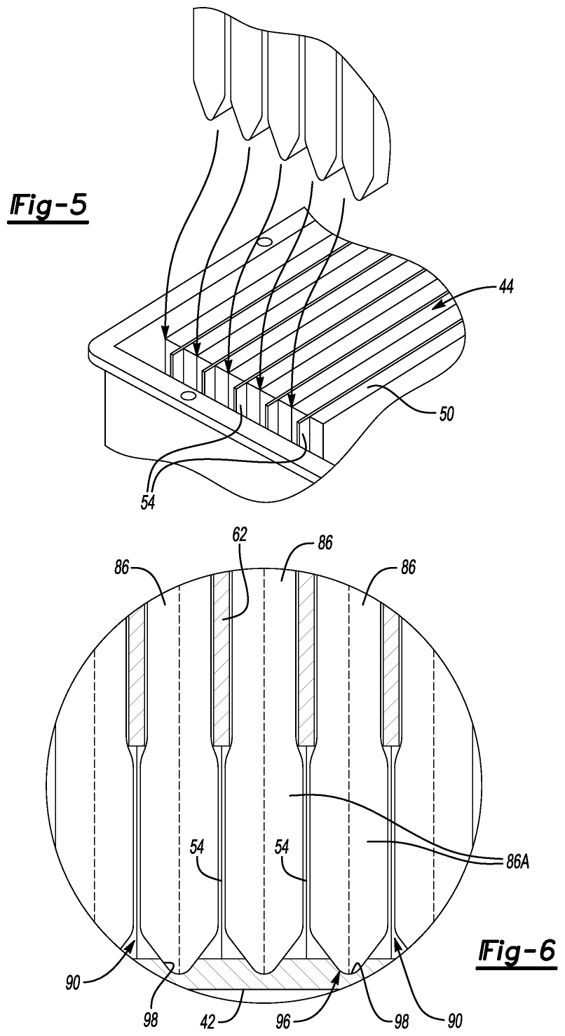

With reference now to FIGS. 4 to 7C and continuing reference to FIGS. 2 and 3, the thermal barrier 78, in the exemplary embodiment, has a plurality of fingers 86 spaced from each other to provide a plurality of slots 90. When the thermal barrier 78 is installed within the battery pack 14, the slots 90 each receive a portion of one or more of the terminal tabs 62 that extend from one or more of the battery cells 50. The slots 90 additionally receive a portion of the crimped edge 54 from one or more of the battery cells 50.

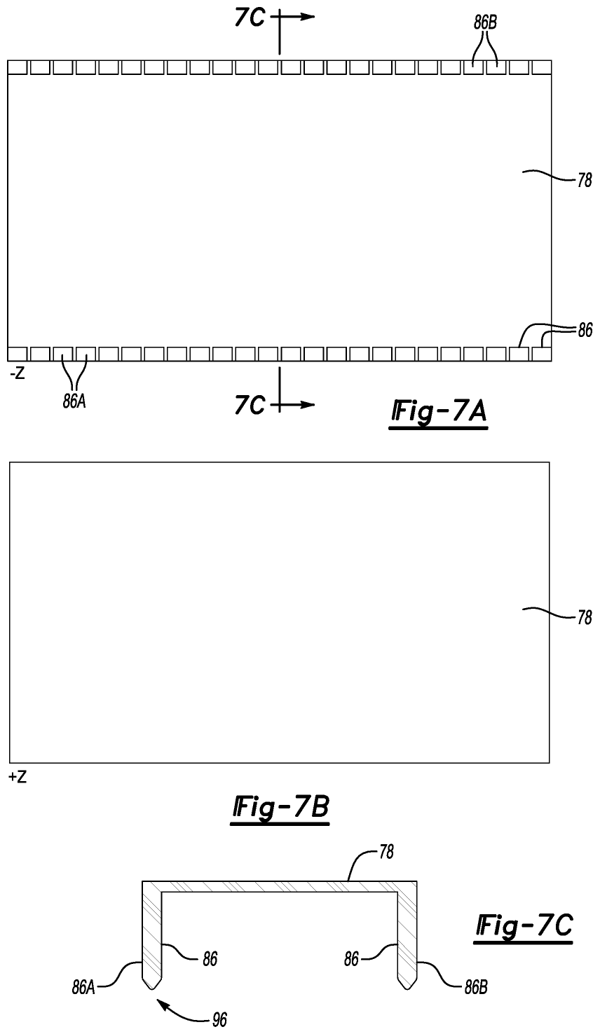

In this example, the thermal barrier 78 includes a plurality of first fingers 86A that can be placed along one of the outboard sides 82 of one of the cell stacks 30 and a plurality of second fingers 86B that can be placed along an opposing outboard side of that cell stack 30. The plurality of first fingers 86A and the plurality of second FIGS. 86B each extend longitudinally from a thermal barrier base 94 that is disposed alongside another side of the cell stack 30—here an upper side of the cell stack 30. The outboard sides 82 are substantially parallel to each other in this example. The third side is transverse, here perpendicular, to the outboard sides 82. A section of the thermal barrier taken through the one of the first fingers, the base, and one of the second fingers has a “C” shape as shown in FIG. 7C.

The first fingers 86A and second fingers 86B each include a tapered end portion 96. The first fingers 86A and second fingers 86B each extend longitudinally from the thermal barrier base 94 to the tapered end portion 96. During installation, the tapered end portions 96 can help to guide the first fingers 86A and second fingers 86B into an installed position.

The enclosure tray 42 can include recessed features 98 that each receive part of one of the tapered end portions 96. Receiving the tapered end portions 96 within the recessed features 98 can help to align and locate the fingers 86 during assembly.

In this example, the first fingers 86A, the second fingers 86B, and the thermal barrier base 94 are a molded, closed-cell foam structure. In another example, the first fingers 86A and the second fingers 86B could be a first material, such as the closed-cell foam, and the thermal barrier base 94 a second, different material, such as a polymer-based material.

In some examples, the thermal barrier 78 can include an internal stiffener, which can help to stiffen and stabilized especially during installation. The internal stiffener could be a polymer-based material or a relatively rigid foam.

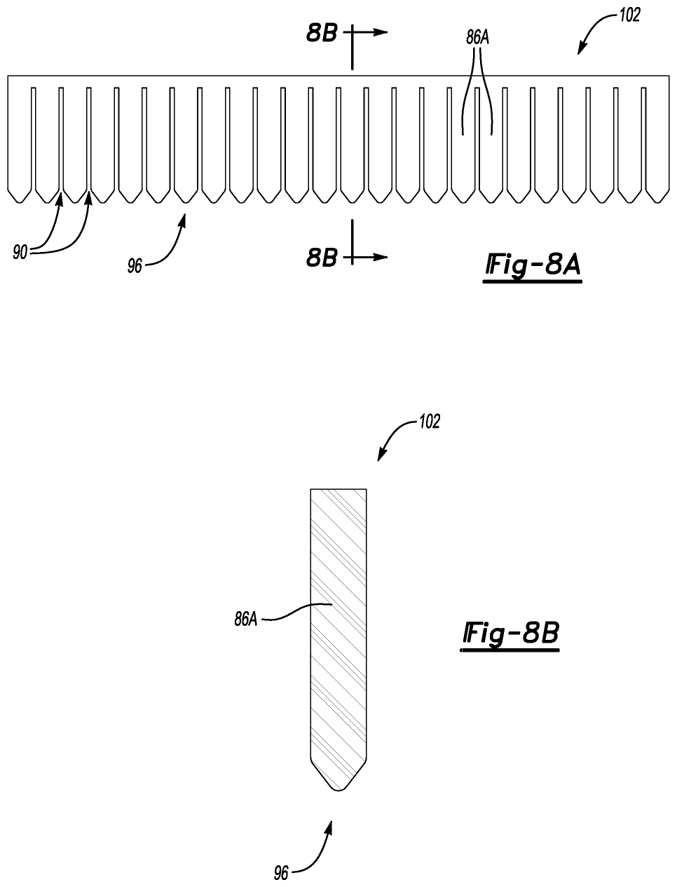

With reference to FIGS. 8A and 8B, in another embodiment, the first fingers 86A and the second fingers 86B are each part of separate comb-style thermal barrier structures. The first fingers 86A can be, for example, part of a first thermal barrier comb 102 that can be disposed along one of the outboard sides 82 of the cell stack 30. The first thermal barrier comb 102 does not include a thermal barrier base spanning over a vertically upper side of the associated battery array. The second fingers 86B can be part of a second thermal barrier comb (not shown) that can be disposed along an opposing outboard side 82 of the cell stack 30.

An exemplary method of providing a thermal barrier for the battery pack 14 of FIG. 2 can include the placing of the cell stacks 30 within the interior area 44 Next, the thermal barrier 78 is inserted into the interior area 44. The thermal barrier 78 is inserted such that at least one of the terminal tabs 62 is received within one of the slots 90 of the thermal barrier 78. The thermal barrier 78 can be installed to the cell stack 30 from above or below. In some examples, such as when the thermal barrier base 94 spans beneath a vertical bottom of the cell stack 30 can sandwich a thermal exchange plate against the cell stack 30.

Features of the disclosed examples include providing a thermal barrier that facilitates installation due to, among other things, reducing part complexity. Multiple fingers of the thermal barrier can be simultaneously installed, rather than individually installed. This can reduce build complexity and tooling complexity. The thermal barrier can be a closed cell foam, which can have closed cell edges that facilitate reduced moisture absorption. Liquid foam, in some examples, is not required. Tapered ends of the exemplary foam fingers help to locate the foam fingers during installation

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly that provides an interior area;
a cell stack within the interior area, the cell stack having a plurality of battery cells disposed along a cell stack axis, each battery cell within the plurality of battery cells includes at least one terminal tab that project outward from the cell stack axis; and
a thermal barrier within the interior area, the thermal barrier having a plurality of fingers spaced from each other to provide at least one slot that receives a portion of the at least one terminal tab.

2. The traction battery pack assembly of claim 1, wherein the plurality of fingers includes at least one first finger on a first side of the cell stack, and at least one second finger on an opposite, second side of the cell stack.

3. The traction battery pack assembly of claim 2, wherein the at least one first finger and the at least one second finger each extend longitudinally from a thermal barrier base that is disposed alongside a third side of the cell stack.

4. The traction battery pack assembly of claim 3, wherein a section of the thermal barrier taken through the at least one first finger, the thermal barrier base, and the at least one second finger has a “C” shape.

5. The traction battery pack assembly of claim 3, wherein the third side is transverse to both the first side and the second side.

6. The traction battery pack assembly of claim 3, wherein the at least one first finger extends longitudinally from the thermal barrier base to a tapered end portion, wherein the at least one second finger extends longitudinally from the thermal barrier base to a tapered end portion.

7. The traction battery pack assembly of claim 3, wherein the at least one first finger and the at least one second finger are a first material, wherein the thermal barrier base is a second material that is different than the first material.

8. The traction battery pack assembly of claim 7, wherein the first material is a closed cell foam, and the second material is a polymer-based material.

9. The traction battery pack assembly of claim 1, wherein the plurality of fingers are a plurality of first fingers that are part of a first thermal barrier comb disposed along a first side of the cell stack, and further comprising a second thermal barrier comb disposed along an opposite second side of the cell stack, the second thermal barrier comb having a plurality of second fingers spaced from each other to provide at least one slot that receives a portion of at least one of the plurality of terminal tabs.

10. The traction battery pack assembly of claim 1, wherein the thermal barrier is a closed cell foam.

11. The traction battery pack assembly of claim 1, wherein the cell stack is a first cell stack, and further comprising at least one second cell stack within the interior area.

12. The traction battery pack assembly of claim 1, wherein the plurality of battery cells are a plurality of pouch-style battery cells, each pouch-style battery cell having a crimped edge that projects outward from the cell stack axis about a circumferential perimeter of the pouch-style battery cell, wherein the at least one slot receives a portion of at least one of the crimped edge.

13. The traction battery pack assembly of claim 12, wherein each of the terminal tabs within the plurality of terminal tabs extends through one of the crimped edges.

14. A traction battery pack assembly, comprising:
a thermal barrier having a plurality of fingers spaced from each other to provide a plurality of slots, each of the slots within the plurality of slots configured to receive a portion of at least one terminal tab that extends from a battery cell.

15. The traction battery pack assembly of claim 14, wherein the thermal barrier is a closed-cell foam.

16. A method of providing a thermal barrier within a battery pack, comprising:
placing a cell stack within an interior area of an enclosure;
inserting a thermal barrier into the interior area; and
during the inserting, receiving at least one tab terminal of the cell stack within a slot of the thermal barrier.

17. The method of claim 16, wherein the slot is provided between a first finger and a second finger of the thermal barrier.

18. The method of claim 17, wherein the first finger and the second finger are closed-cell foam.

19. The method of claim 17, wherein the first finger and the second finger each have a tapered end portion.

20. The method of claim 17, wherein the first finger and the second finger each extend longitudinally from a thermal barrier base.
